(19) United States
(12) Patent Application Publication
(10) Pub. No.: US 2004/0036444 A1
(43) Pub. Date: Feb. 26, 2004

(54) Module battery

(75) Inventor: Etsuo Oogami, Atsugi-shi (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/603,782

(22) Filed: Jun. 26, 2003

(30) Foreign Application Priority Data
Jul. 4, 2002 (JP) 2002-196215

(51) Int. Cl. H02J 7/00

(52) U.S. Cl. 320/110

(57) ABSTRACT

A module battery which includes battery packs each constituted of battery cells and a packing case. Each of the battery cells has a power generating element sealed in a film and a pair of electrode tabs connected thereto. The packing case is provided with an opening for allowing the electrode tabs of the battery cell to extend out of the packing case.

### BACKGROUND OF THE INVENTION

1. Field of the Invention

The present invention relates to a module battery and, more particularly, to a module battery which includes a plurality of stacked type battery cells, each having a power generating element (electrode stack) covered with a packaging film and hermetically sealed therein.

2. Description of Related Art

In recent years, global air pollution caused by automobile emissions, vehicles powered by electric motor, and hybrid cars powered by a combination of an engine and an electric motor have been brought to international attention. Development of high-power batteries for use in these vehicles is currently an important industrial concern.

One realization of such a high-power battery is a module battery composed by combining a number of high power and high energy density battery cells, such as lithium ion cells. As a structure of such a module battery, the Japanese Patent Laid-open No. 2001-114157 discloses a structure in which battery cells are stacked in a row or a plurality of rows and wired to form subassemblies and the subassemblies are accommodated in a module case.

### SUMMARY OF THE INVENTION

In the above structure of the module battery, since each battery cell, as well as each subassembly of the battery cells, has low rigidity, assembly work including wiring work is complicated.

The present invention was made in the light of this problem. An object of the present invention is to provide a module battery facilitating said assembly work.

An aspect of the present invention is a module battery comprising: a battery pack comprising: at least one battery cell having a power generating element sealed in a film and a pair of electrode tabs connected to the power generating element; and a packing case for accommodating the battery cell, wherein the packing case is provided with an opening for allowing the electrode tabs of the battery cell in the packing case to extend out of the packing case.

### BRIEF DESCRIPTION OF THE DRAWINGS

The invention will now be described with reference to the accompanying drawings wherein:

FIG. 1 is a top view of a module battery according to an embodiment of the present invention. In the drawing, output and input terminals 21 and 22 are provided in the left end of the top face of the module battery. Hereinafter, for convenience of explanation, the side where the output and input terminals 21 and 22 are provided is defined as the front side of the module battery.

FIG. 2 is a side view of the module battery of FIG. 1.

FIG. 3 is a front view of the module battery of FIG. 1, when viewed in arrow III direction in FIG. 2.

FIG. 4 is a sectional view of the module battery of FIG. 1 taken along line IV-IV in FIG. 2.

FIG. 5 is a side view of the module battery of FIG. 1 partially including a section thereof, when viewed in arrow V direction in FIG. 1.

FIG. 6 is a sectional view of the module battery of FIG. 1 taken along line VI-VI in FIG. 1.

FIGS. 7A to 7D show a case half constituting a packing case for each of the battery packs of the module battery of FIG. 1. FIGS. 7A and 7C show inner and outer faces of the case half, respectively. FIG. 7B shows a side face of the case half, the side face being directed to a top or bottom face of the module battery when assembled. FIG. 7D shows a front face of the case half.

FIG. 8 is a perspective view of a stacked type battery cell accommodated and held in each battery pack of the module battery of FIG. 1. Regarding the tabs extending to the left and right in the drawing, the left one is a positive electrode tab 14, and the right one is a negative electrode tab 15.

FIG. 9 is a top view of the battery cell of FIG. 8.

FIG. 10 is a sectional view of the battery cell of FIG. 8 taken along line X-X in FIG. 9.

FIG. 11 is a front view of the battery pack of the module battery of FIG. 1.

FIG. 12 is an exploded view of the battery pack of FIG. 11.

FIGS. 13A and 13B show top and side faces of a modification example of the case half of the battery pack of FIG. 11, respectively.

### DETAILED DESCRIPTION OF THE PREFERED EMBODIMENT

An embodiment of the present invention will be explained below with reference to the drawings, wherein like members are designated by like reference characters.

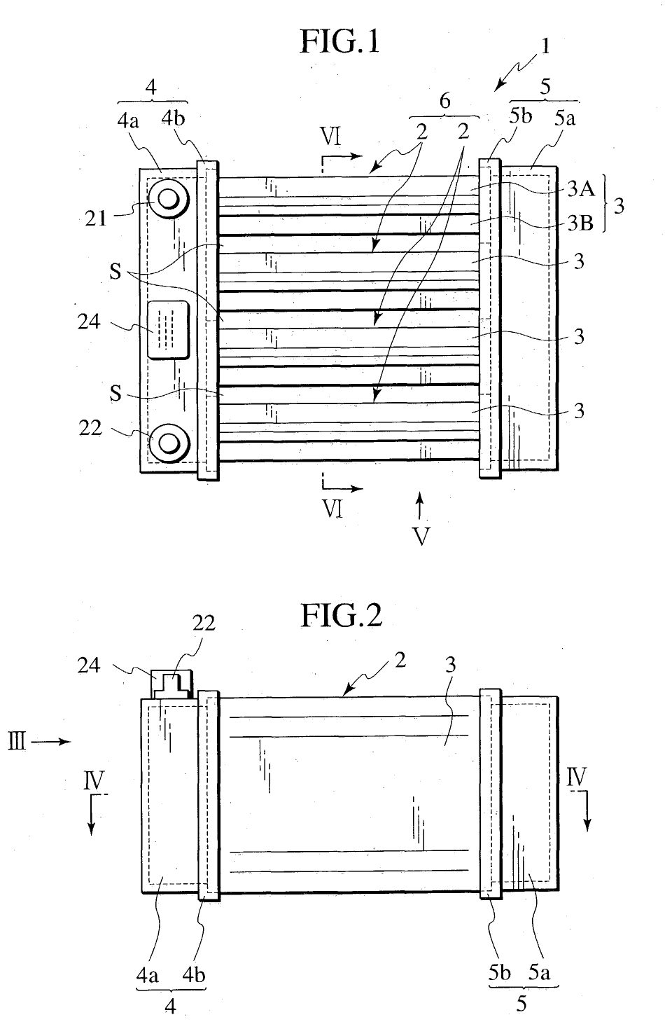

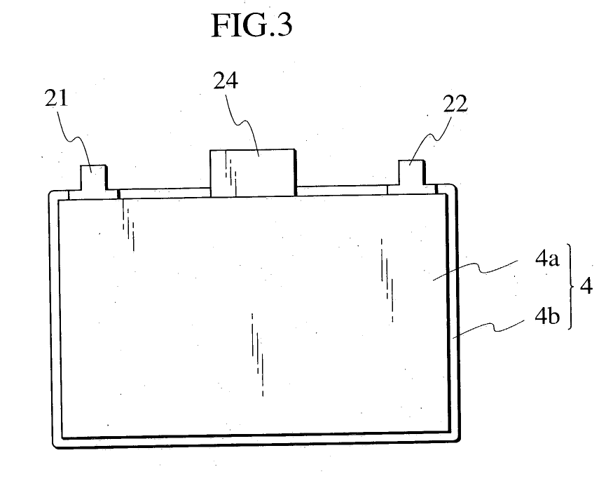

As shown in FIGS. 1 to 6, a module battery 1 includes a stacked body 6 and a pair of battery pack holders 4 and 5. The stacked body 6 is consisted of a plurality of battery packs 2 which are stacked on one another. The battery pack holders 4 and 5 hold the stacked body 6 at front and rear ends of the module battery 1.

(Battery Pack)

Each of the battery packs 2 includes a plurality of stacked type battery cells 10 and a tubular packing case 3 for accommodating and holding these battery cells 10. In this embodiment, the packing case 3 accommodates four battery cells 10, but the number of accommodated battery cells 10 can be arbitrary.

(Battery Cell)

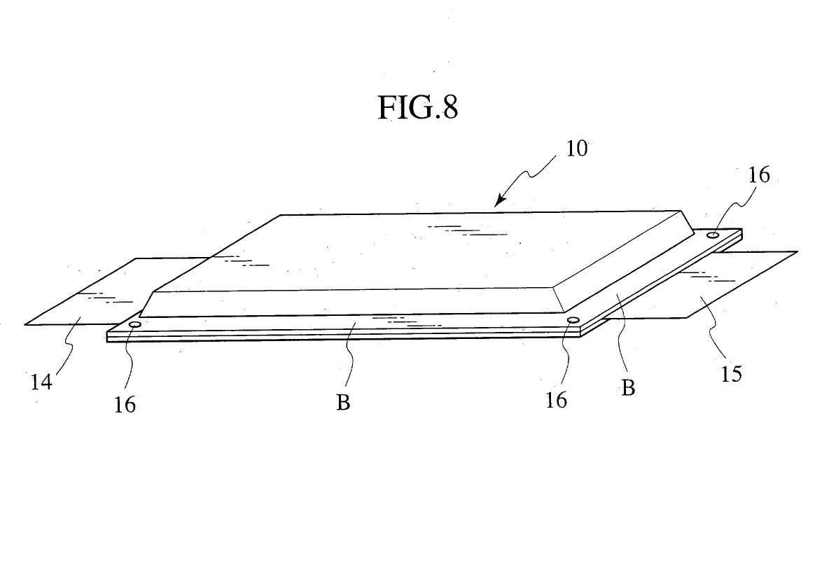

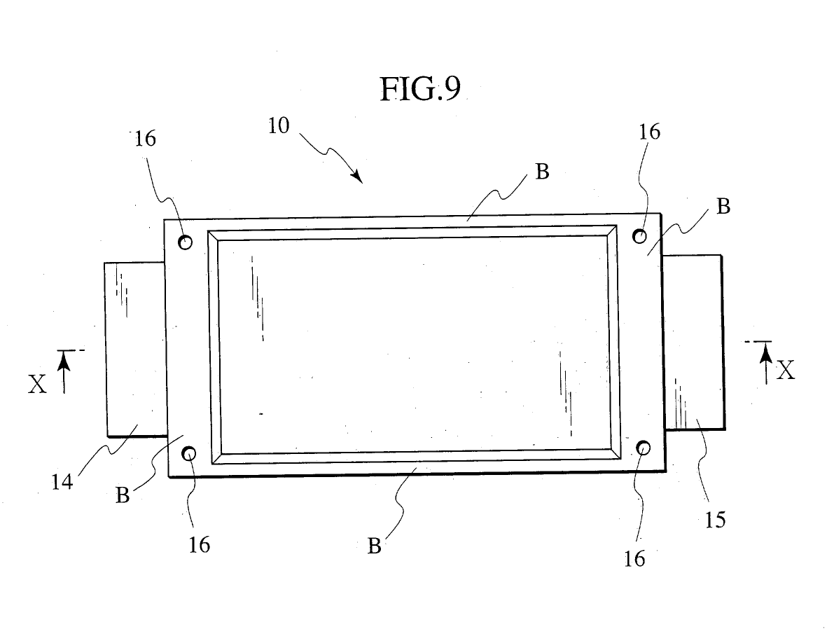

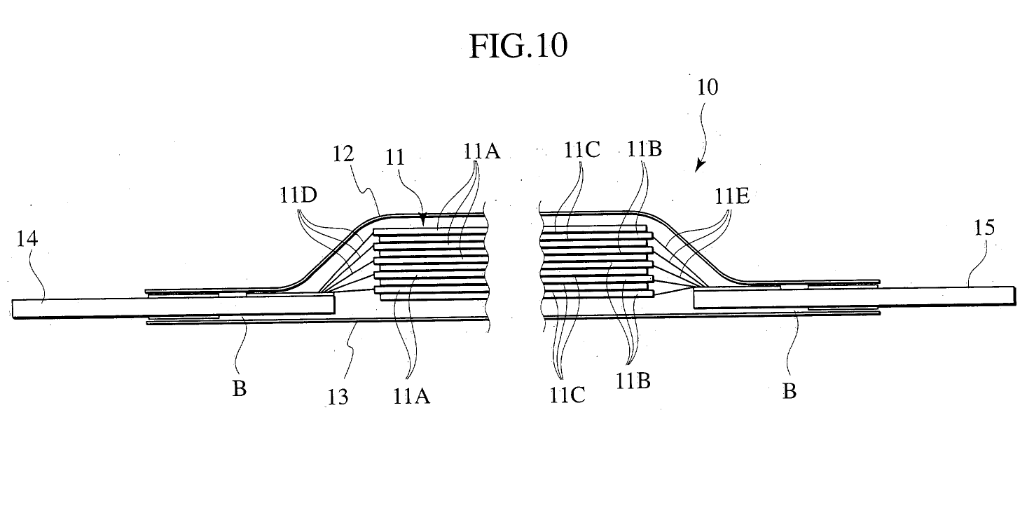

As shown in FIGS. 8 to 10, the battery cell 10 in the battery pack 2 includes a flat electrode stack 11 of power generating elements and a pair of laminate films 12 and 13 as packaging films which cover the electrode stack 11. The laminate film 12 covers the top face of the electrode stack 11, and the laminate film 13 covers the bottom face of the electrode stack 11. The laminate films 12 and 13 are joined with each other at peripheries thereof (a joint portion B). Between the laminate films 12 and 13, an electrolyte is hermetically sealed together with the electrode stack 11.

The electrode stack 11 includes a plurality of positive electrode plates 11A and a plurality of negative electrode plates 11B, which are alternately stacked with separators 11C interposed therebetween. Each of the positive electrode plates 11A is connected to a positive electrode tab 14 through a positive lead 11D. Each of the negative electrode plates 11B is connected to a negative electrode tab 15 through a negative lead 11E. These positive and negative electrode tabs 14 and 15 extend outward from the joint portion B of the laminate films 12 and 13 at both ends of the battery cell 10 in a longitudinal direction.

The positive and negative electrode tabs 14 and 15 are formed of Aluminum (Al) and Nickel (Ni) foils, respectively. These positive and negative electrode tabs 14 and 15 maybe formed of metal foils such as Aluminum (Al), Copper (Cu), Nickel (Ni), and Iron (Fe) foils. Each of the laminate films 12 and 13 is composed of a nylon layer α as a resin layer, an adhesive layer β, an aluminum foil layer γ as a metal layer, and a polyethylene (PE) or polypropylene (PP) layer δ as a resin layer from the outside to the inside of the battery cell 10.

(Packing Case)

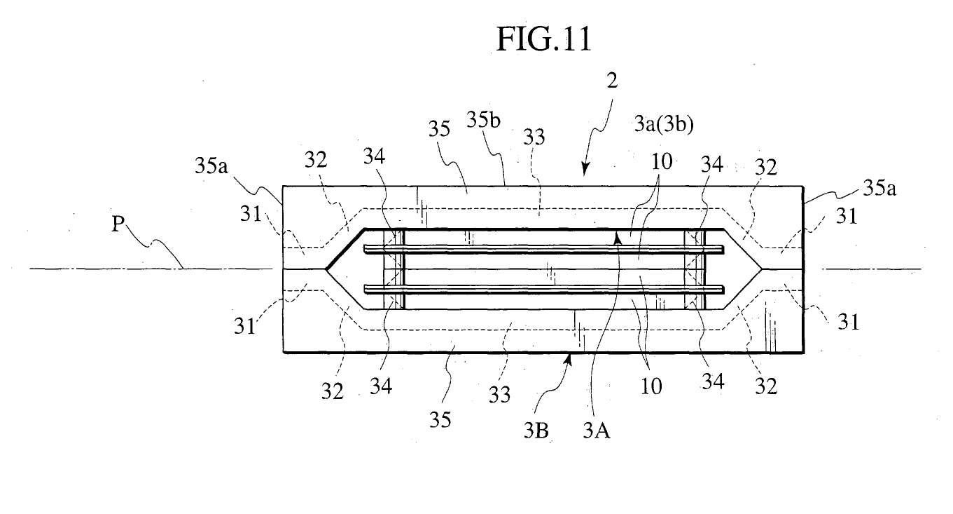

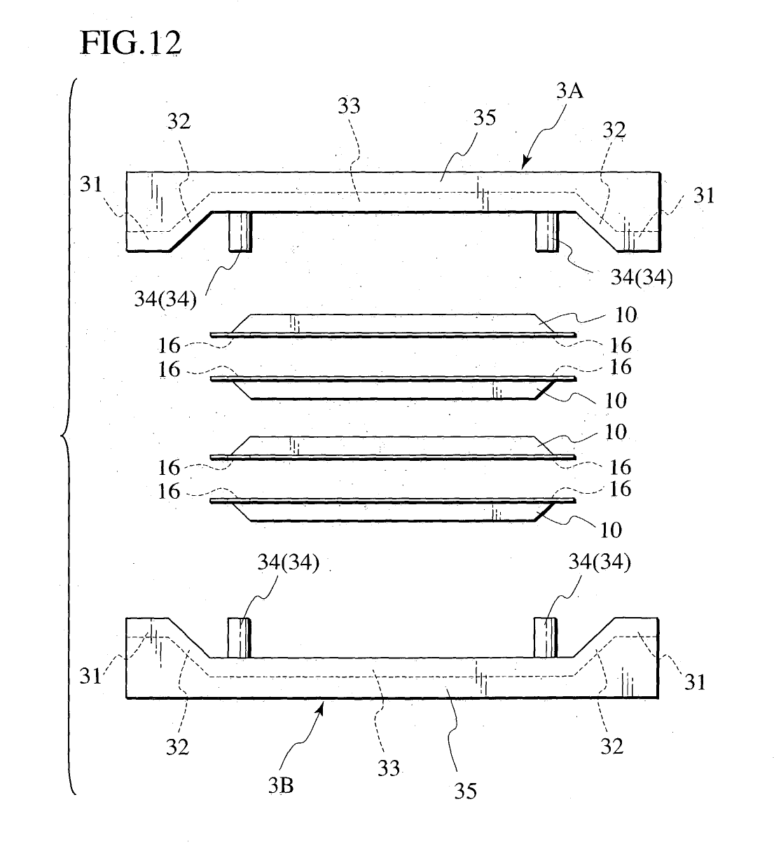

As shown in FIGS. 11 and 12, the packing case 3 for the battery pack 2 has a tubular shape with a hexagonal section and collectively accommodates and holds four battery cells 10 stacked on one another. In both ends of the packing case 3 in a longitudinal direction, openings 3a and 3b are provided for allowing the electrode tabs (positive and negative electrode tabs 14 and 15) of the accommodated battery cells 10 to extend out of the packing case 3. The packing case 3 is consisted of a pair of case halves 3A and 3B, which sandwich and hold the battery cells 10. These case halves 3A and 3B are respectively formed to be a shape symmetrical with respect to a partition plane P and superposed on each other to be joined by ultrasonic bonding or the like. Each of the case halves 3A and 3B is formed to have a pair of joint walls 31, a pair of sloping walls 32, and a holding wall 33. The joint walls31 are formed to extend in the longitudinal direction at both outer edges in a width direction of each of the case halves 3A and 3B, and are joined with another pair of joint walls 31 of the other case half. Each of the sloping walls 32 are formed to extend inward in the width direction from inner edges of the respective joint walls 31 at a slant with increasing distance from the other case half. The holding wall 33 is formed to connect inner edges of both of the sloping walls 32 in parallel to the joint walls 31. The holding wall 33 abuts on the top or bottom battery cell 10 among the battery cells 10 which are stacked and held in the packing case 3. The holding wall 33 and the pair of sloping walls 32 cooperate to form a concave portion on an inner side of each of the case halves 3A and 3B, the concave portion being concave with respect to the partition plane P, in other words, a joint face of the joint walls 31. When the case halves 3A and 3B are joined together, inner faces of the concave portions cooperate to define a space for accommodating the battery cells 10 therebetween. The holding wall 33 is provided with locate pins 34 at four corners on its inner face. Each of the locate pins 34 projects at a right angle from the inner face of the holding wall 33 and extends in a direction that the case halves 3A and 3B are superposed. The battery cell 10 is provided, at positions corresponding to the locate pins 34 in four corners of its joint portion (thin wall portion) B, with through-holes 16 to which the respective locate pins 34 is fitted. The battery cells 10 are located and properly positioned by fitting the locate pins 34 into the respective through-holes 16 thereof, as the battery cells 10 are stacked within the case halves 3A and 3B.

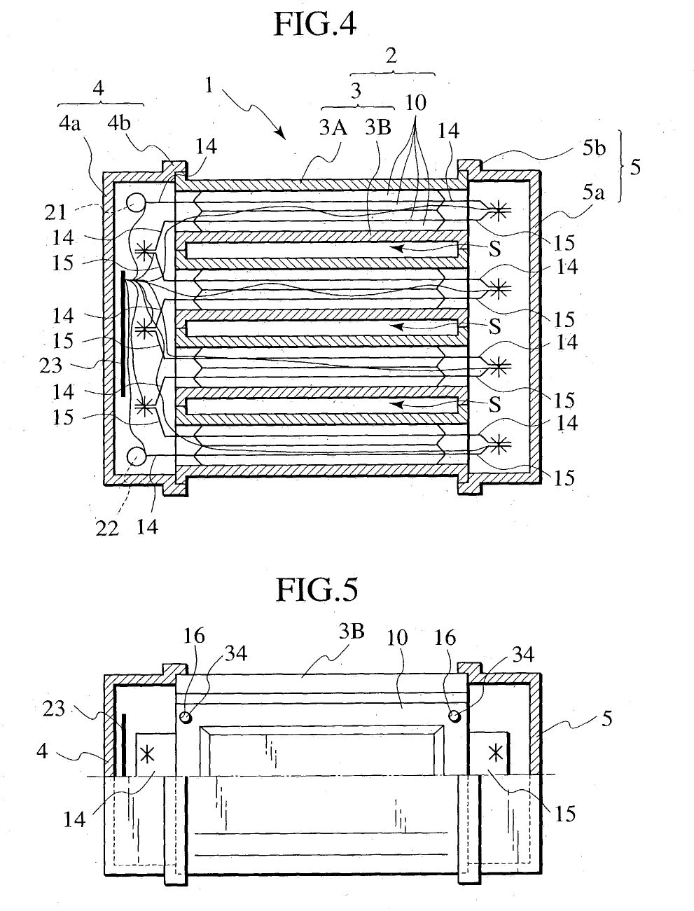

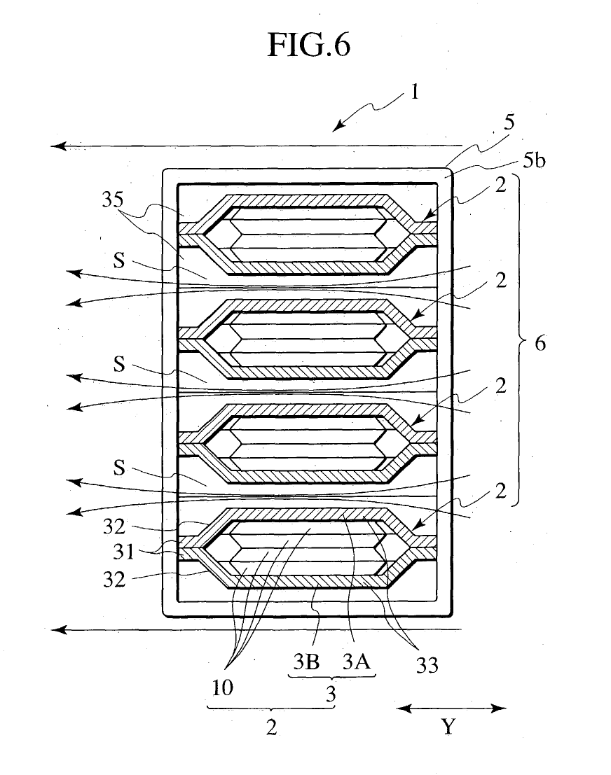

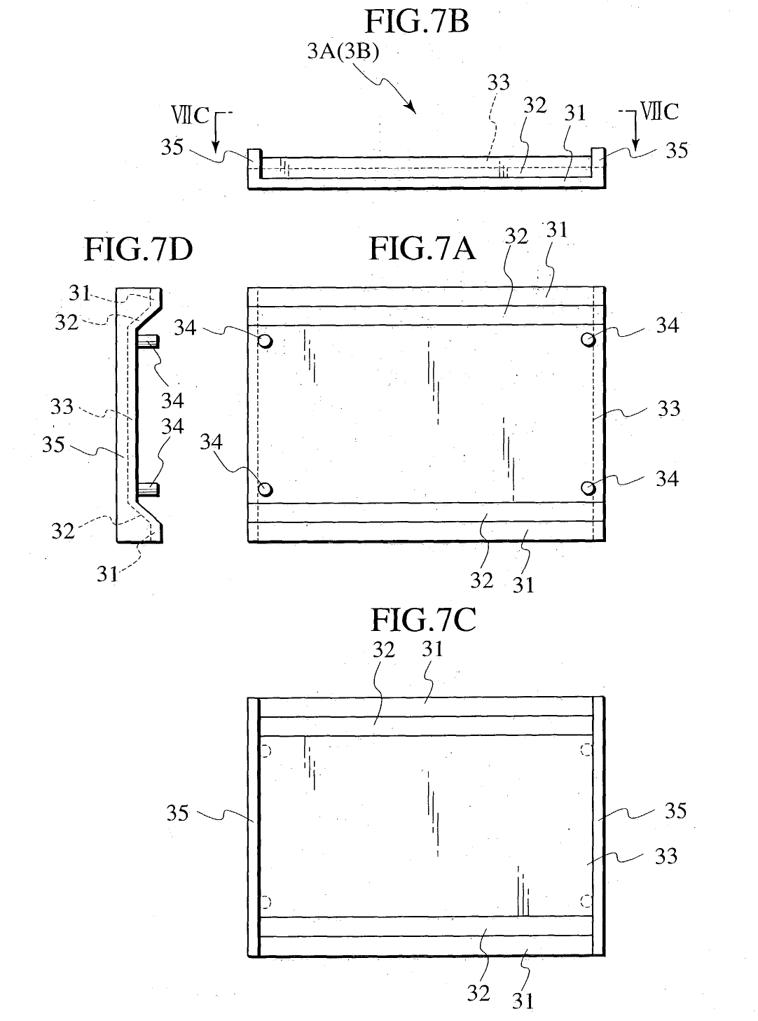

The packing case 3 is provided with flanges 35 extending in a stacking direction of the battery packs 2 from peripheries of the openings 3a and 3b. Specifically, the flanges 35 extend outward in a direction perpendicular to the longitudinal direction of the case halves 3A and 3B from front and rear ends of the joint walls 31, the sloping walls 32, and the holding wall 33 of each of the case halves 3A and 3B. Each of the flanges 35 is formed to be in a planer shape having straight sides 35a on both ends in the width direction of the packing case 3 and a straight side 35b parallel to the partition plane P. The flange 35 is brought into contact at its side 35b with the flange 35 of another packing case 3, which is adjacent thereto when the packing cases 3 are stacked. As shown in FIG. 11, when the case halves 3A and 3B are joined together, the adjacent flanges 35 of both of the case halves 3A and 3B lie in a plane forming a rectangular flange as a whole. When another packing case 3 is stacked, all the flanges 35 of the adjacent packing cases 3 lie in the same plane, and the sides 35a of all the flanges 35 are linearly aligned, thus forming a rectangular board as a whole. Since the flange of the joined case halves 3A and 3B is formed in a rectangular shape, connection between the stacked packing cases 3 at the side 35b of the flanges 35 can be made airtight. As shown in FIGS. 1, 4 and 6, when a plurality of the packing cases 3 (battery packs 2) are stacked, the flanges 35 serve as spacers to leave spaces S between the battery packs 2 adjacent to each other in the stacking direction. Cooling of the battery packs 2 is promoted by the spaces S. Specifically, the adjacent packing cases 3 cooperate to define the space S as an air passage, between outer surfaces of the joint walls 31, sloping walls 32, holding walls 33, and flanges 35 thereof. Air (fluid) flows through the air passages in a direction toward the front or back of the sheet of FIG. 4 or in the left or right direction in FIG. 6. The heat of the battery packs 2 is thus extracted by the flowing air.

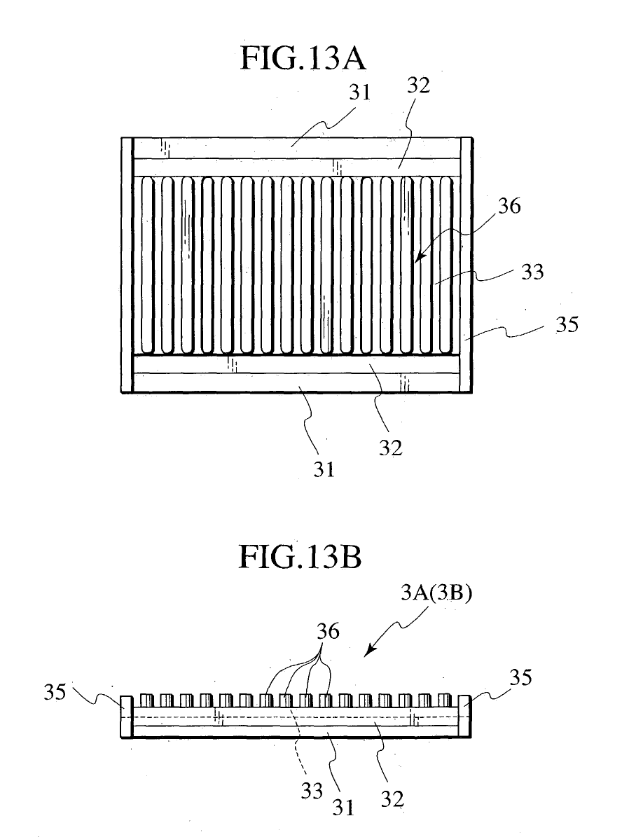

As shown in FIG. 6, each of the air passages is formed to be wider at both end portions in the air-f lowing direction Y, which corresponds to the joint walls 31, than a middle portion in the air-flowing direction Y, which corresponds to the holding walls 33, in order to smoothen the flow of air into the spaces S. In addition, each of the air passages is formed to have its width gradually increasing in the air-flowing direction Y from the middle portion toward both of the end portions, so that air flows into the spaces S more smoothly. The packing cases 3 are thus excellent in cooling performance. Note that it is sufficient to make at least the upstream end portion wider than the other portions. Moreover, as shown in FIG. 13, the provision of cooling fins 36 on the outer surface of the case half 3A (3B) of the packing case 3, which extends into the space S, further enhances the cooling capability of the packing case 3.

(Battery Pack Holder)

The stacked body (subassembly) 6 is subassembled such that a plurality of the battery packs 2 are stacked with front and rear ends thereof aligned. The battery pack holders 4 and 5 hold the stacked body 6 from front and rear ends thereof. The battery pack holders 4 and 5 are formed to have body portions 4aand 5a in container shapes and fitting portions 4b and 5b provided in the peripheries of the body portions 4a and 5a. Each of the fitting portions 4b and 5b receives and fits around the periphery (sides 35a and 35b) of the flanges 35 of the packing cases 3 (battery packs 2) constituting the stacked body 6. With the fitting portions 4b and 5b fitted around the flanges 35 of the packing cases 3 of the stacked body 6, the battery pack holders 4 and 5 collectively hold the plurality of packing cases 3 (battery packs 2) and collectively cover the openings 3a and 3b at the both ends of the packing cases 3 to form airtight spaces within the body portions 4a and 5a thereof.

The battery pack holder 4 at the front is provided with output and input terminals 21 and 22 which are connected to the positive electrode tabs 14 or the negative electrode tabs 15 of the battery cells 10 through wires. The module battery 1 is charged and discharged through the output and input terminals 21 and 22. Furthermore, a control circuit board 23 and a control connector 24 connected thereto are fixed inside the battery pack holder 4. The control circuit board 23 includes an overcurrent protection device or the like and controls the charge and discharge of the module battery 1.

(Assembly Process)

The module battery 1 thus constituted is assembled as follows.

First, as shown in FIGS. 11 and 12, the battery cells 10 are positioned in the respective case halves 3A and 3B to be temporarily held, with the through-holes 16 thereof fitted to the locate pins 34 of the respective case halves 3A and 3B. These case halves 3A and 3B are superposed on each other together with the battery cells 10 temporarily held therein. Then, the joint walls 31 and the locate pins 34 of the case half 3A are respectively joined with the joint walls 31 and the locate pins 16 of the case half 3B by, for example, ultrasonic bonding. Each of the battery packs 2 is thus assembled.

Next, the above described battery packs 2 are stacked with the front and rear ends thereof aligned to form the stacked body 6. The electrode tabs 14 and 15 extending out of each opening 3a or 3b are connected to each other and wired. At this point, the stacked body 6 may be the battery packs 2 temporarily stacked and bundled by using bands, jigs or the like, or the battery packs 2 joined to each other.

Lastly, the battery pack holders 4 and 5 are respectively fitted to the front and rear ends of the stacked body 6, with the fitting portions 4b and 5b thereof fitted around the flanges 35 of the packing cases 3. The stacked body 6 is then joined with the battery pack holders 4 and 5 by, for example, ultrasonic bonding to form the module battery 1.

(Raw materials of Cell)

The module battery 1 of this embodiment employs a lithium ion secondary battery with a high energy density and high power output for an on-vehicle application, the materials of which will be explained below.

As a positive electrode active material forming the positive electrode plate 11A, a compound is contained that includes lithium nickel composite oxides, in particular, compounds expressed by a general formula LiNi₁₋ₓMₓO₂. Here, x lies in a range of 0.01≦x≦0.05, and M represents at least one element selected from iron (Fe), cobalt (Co), manganese (Mn), copper (Cu), zinc (Zn), aluminum (Al), tin (Sn), boron (B), gallium (Ga), chromium (Cr), vanadium (V), titanium (Ti), magnesium (Mg), calcium (Ca) and strontium (Sr).

Further, the positive electrode may contain other positive electrode active material than the lithium nickel composite oxides. This material may include lithium manganese composite oxides that form compounds expressed by a general formula Li_{y}Mn_{2-z}M′_{z}O₄. Here, y lies in a range of 0.9≦y≦1.2 while z lies in a range of 0.01≦z≦0.5, and M′ represents at least one element selected from Fe, Co, Ni, Cu, Zn, Al, Sn, B, Ga, Cr, V, Ti, Mg, Ca and Sr. Alternately, this material may include lithium cobalt composite oxides that form compounds expressed by a general formula LiCo₁₋ₓM″ₓO₂. Here, a range of x lies in 0.01≦x≦0.5, and M″ represents at least one element selected from Fe, Ni, Mn, Cu, Zn, Al, Sn, B, Ga, Cr, V, Ti, Mg, Ca and Sr.

Although there are no particular limitations in the manufacturing methods of the lithium nickel composite oxides, the lithium manganese composite oxides and the lithium cobalt composite oxides, these-compounds may be obtained by mixing carbonates such as lithium, nickel, manganese and cobalt at ratios depending on constituents thereof and baking these carbonates in a temperature ranging from 600° C. to 1000° C. Also, the starting materials may not be limited to the carbonates and can also be similarly synthesized from hydroxides, oxides, nitrates and organic acid salts.

Also, the positive electrode material such as the lithium nickel composite oxides and the lithium manganese composite oxides should preferably have an average particle size of 30 μm or below.

Further, the negative electrode plate 11B is formed of the negative electrode active material with a specific surface area in a range from 0.05 m²/g to 2 m²/g. As a result of the negative electrode material with the specific surface area of the above range, it is possible to adequately restrict an excessive amount of a solid electrolyte interface layer (SEI layer) from being formed on the negative electrode surface.

With the negative electrode active material having a specific surface area of less than 0.05 m²/g, since an area available for lithium ions to transfer is extremely small, the lithium ions doped into the negative electrode active material during the charging cycle become too hard to be sufficiently doped out from the negative electrode active material during the discharging cycle, resulting in deterioration in the charging and discharging efficiency. Conversely, with the negative electrode active material having a specific surface area of greater than 2 m²/g, it is difficult to control an excessive amount of the SEI layer from being formed on the negative electrode surface.

The negative electrode active material may include any material that allows the lithium ions to be doped into or out of the material at a voltage versus lithium of less than 2.0 volts. More particularly, carbonaceous materials may be used which involve a non-graphitizable carbon material, artificial graphite, natural graphite, pyrolytic graphite, cokes including pitch coke, needle coke and petroleum coke, graphite, glassy carbon, a sintered material of polymers formed by baking and carbonizing phenol resin or furan resin at an appropriate temperature, carbon fiber, activated carbon and carbon black.

Further, a metal, that is able to form an alloy with lithium, and an alloy thereof can also be used and, in particular, these materials include oxide products or nitride products, that allow the lithium ions to be doped into or out of the material at a relatively low voltage potential, such as iron oxide, ruthenium oxide, molybdenum oxide, tungsten oxide, tin oxide and main group elements of group 13. In addition thereto, these materials include elements such as silicon (Si) and tin (Sn), or alloys of Si and Sn represented by a formula MₓSi and MₓSn (wherein M represents more than one metallic element except for Si or Sn) Among these, it is particularly preferable for Si or the Si alloys to be used.

Further, the electrolyte may include a liquid state, a so-called electrolysis solution composed of electrolyte salts dissolved in and adjusted in a non-aqueous solvent, polymer gel electrolyte composed of the electrolyte salt dissolved in the non-aqueous solvent which is retained in a polymer matrix, and polymer electrolyte composed of the electrolyte salt dissolved in the polymer.

When using the polymer gel electrolyte as the non-aqueous electrolyte, the polymer to be used includes poly(vinylidene fluoride) and polyacrylonitrile. Also, when using the polymer electrolyte, a polymer of polyethylene oxide (PEO) may be used.

The non-aqueous solvent may include any kind of solvent if it remains in a non-aqueous solvent heretofore used in a secondary battery using such kinds of non-aqueous electrolyte. As the non-aqueous solvent, propylene carbonate, ethylene carbonate, 1,2-dimethoxyethane, diethyl carbonate, dimethyl carbonate, γ-butyrolactone, tetrahydrofuran, 1,3-dioxolane, 4-methyl-1,3-dioxolane, diethylether, sulfolane, methyl sulfolane, acetonitrile and propionitrile can be used. Also, these non-aqueous solvents may be used as a single kind or in a mixture of more than two kinds.

Particularly, the non-aqueous solvent should preferably contain an unsaturated carbonate. More particularly, it is more preferable for the non-aqueous solvent to contain vinylene carbonate. The presence of the unsaturated carbonate contained as the non-aqueous solvent enables an effect, derived in the negative electrode active material from the property (a function of a protective layer) of the SEI layer, to be obtained and it is likely that an excessive discharging-resistant characteristic is further improved.

Further, the unsaturated carbonate should be preferably contained in the electrolyte in a range from 0.05 wt % to 5 wt % and, more preferably, in a range from 0.5 wt % to 3 wt %. With the amount of content of the unsaturated carbonate being weighed in the above range, a non-aqueous secondary battery is provided which has a high initial discharging capacity with a high energy density.

The electrolyte salt may not be limited to a particular composition provided that it forms a lithium salt presenting anion conductivity and may include LiClO₄, LiAsF₆, LiPF₆, LiBF₄, LiB(C₆H₅)₄, LiCl, LiBr, CH₃SO₃Li and CF₃SO₃Li. The electrolyte salt may be used as a single kind or may be used in a mixture of more than two kinds.

The use of such a lithium ion secondary battery provides the module battery, of the present embodiment, with a structure suited for use in an on-vehicle application.

According to the module battery 1 of the above described embodiment, the packing case 3 accommodates and holds a plurality of the battery cells 10 and is provided with the openings 3a and 3b for allowing the electrode tabs 14 and 15 of the battery cells 10 to extend out thereof. Accordingly, regardless of the low rigidity of the cells 10, the electrode tabs 14 and 15 can be connected to each other and be wired with a plurality of the battery packs 2 stacked as a subassembly, thus facilitating the assembly work of the module battery 1.

Moreover, since the battery pack holders 4 and 5 hold the stacked body 6 constituted of the stacked battery packs 2, the assembly work can be further facilitated. These battery pack holders 4 and 5 collectively cover the openings 3a and 3b, respectively, of all the battery packs 2 to hermetically seal the battery packs 2. Accordingly, all cells 10, wiring and electrical connections are accommodated in the sealed space and protected from dust and dirt. The life of the module battery is thus prolonged.

Furthermore, the module battery 1 is efficiently cooled by virtue of the spaces S provided between the battery packs 2 adjacent to each other in the stacking direction.

The sloping walls 32 of the packing cases 3 provide the air passage of each space S with gradually increasing width from the middle portion toward both end portions thereof. Accordingly, the air flows smoothly into the spaces S.

Furthermore, the packing case 3 of battery pack 2 is consisted of the pair of case halves 3A and 3B which sandwich and hold the battery cells 10. Each of the case halves 3A and 3B has the locate pins 34 to stably position and hold the battery cells 10 in the packing case 3. Accordingly, the assembly of each battery pack 2 is facilitated.

Since the pair of case halves 3A and 3B are symmetrical with respect to the partition plane P, components thereof can be shared, thus reducing costs.

Moreover, since the battery cell 10 is a lithium ion secondary battery with high power and energy density, the module battery 1 can be employed as a power source in vehicles.

The preferred embodiment described herein is illustrative and not restrictive, and the invention may be practiced or embodied in other ways without departing from the spirit or essential character thereof. The scope of the invention being indicated by the claims, and all variations which come within the meaning of claims are intended to be embraced herein.

The present disclosure relates to subject matter contained in Japanese Patent Application No. 2002-196215, filed on Jul. 4, 2002, the disclosure of which is expressly incorporated herein by reference in its entirety.

What is claimed is:

1. A module battery comprising:
a battery pack comprising:
at least one battery cell having a power generating element sealed in a film and a pair of electrode tabs connected to the power generating element; and
a packing case for accommodating the battery cell,
wherein the packing case is provided with an opening for allowing the electrode tabs of the battery cell in the packing case to extend out of the packing case.

2. A module battery comprising:
a plurality of battery packs each comprising:
at least one battery cell having a power generating element sealed in a film and a pair of electrode tabs connected to the power generating element; and
a packing case for accommodating the battery cell, wherein the battery packs are stacked on each other; and
a battery pack holder for holding the stacked battery packs together,
wherein each of the packing cases of the battery packs is provided with an opening for allowing the electrode tab of the battery cell in the packing case to extend out of the packing case, and
the battery pack holder covers all the openings of the packing cases to make the stacked battery packs air tight.

3. The module battery according to claim 2, wherein
space is provided between the battery packs adjacent to each other.

4. The module battery according to claim 3, wherein
the space is formed to allow fluid to flow therethrough and at least upstream region of the space is formed to be wider than the other region of the space.

5. The module battery according to claim 3, wherein
the packing case of the battery pack is formed to have a cooling fin extending into the space.

6. The module battery according to claim 1, wherein
the packing case is comprised of a pair of case halves which sandwich and hold the battery cell.

7. The module battery according to claim 6, wherein
at least one of the case halves is formed to have a locate pin, and the battery cell is provided with a through-hole to which the locate pin is fitted.

8. The module battery according to claim 6, wherein
the case halves are symmetrically formed with respect to a plane.

9. The module battery according to claim 2, wherein
each of the packing cases of the battery packs is provided with a flange having sides to be aligned as the packing cases are stacked.

10. The module battery according to claim 2, wherein
each of the packing cases of the battery packs is provided with a flange serving as a spacer to provide space between the adjacent battery packs as the packing cases are stacked.
